(19) United States
(12) Patent Application Publication
(10) Pub. No.: US 2010/0089197 A1
(43) Pub. Date: Apr. 15, 2010

(54) DISCONNECTED PEDAL UNIT IN A MINE-PROTECTED VEHICLE, IN PARTICULAR, A MILITARY VEHICLE

(75) Inventor: Andreas Schramm, Magdeburg (DE)

Correspondence Address: GRIFFIN & SZIPL, PC, SUITE PH-1, 2300 NINTH STREET, SOUTH, ARLINGTON, VA, 22204, US

(73) Assignee: RHEINMETALL LANDSYSTEME GMBH, Kiel, DE (DE)

(21) Appl. No.: 12/522,903

(22) PCT Filed: Jan. 11, 2008
(86) PCT No.: PCT/EP2008/000197

§ 371 Date: Jul. 10, 2009

(30) Foreign Application Priority Data
Jan. 11, 2007 (DE) 10 2007 002 576.0

(51) Int. Cl. G05G 1/32; G05G 1/30; G05G 1/445

(52) U.S. Cl. 74/560

(57) ABSTRACT

Disclosed is a vehicle pedal (1) for actuating a vehicle, wherein the pedal includes at least two metal sheets (10, 20), i.e. a bottom metal sheet (10) and a pedal metal sheet (20), which are spaced apart from one another by at least two springs (14). The bottom metal sheet (10) is provided with sides (12) that form an angle in the front and rear. Suspension points (13) for the springs (14) are arranged on the sides (12) while corresponding suspension points (22) are provided on the pedal metal sheet (20). Only the pedal metal sheet (20) is directly connected to the vehicle floor pan by a pan-mounted pivot bearing (23) so that linear momentum is not transmitted to the driver's foot (2) in case a mine explodes.

This is a National Phase Application in the United States of International Patent Application No. PCT/EP2008/000197 filed Jan. 11, 2008, which claims priority on German Patent Application No. DE 10 2007 002 576.0, filed Jan. 11, 2007. The entire disclosures of the above patent applications are hereby incorporated by reference.

### FIELD OF THE INVENTION

The present invention pertains to a pedal for actuating a vehicle, in particular, a vehicle protected against mines and/or a military vehicle.

### BACKGROUND OF THE INVENTION

A pedal unit in a vehicle is known, which includes a mechanical unit connected to the vehicle itself via control cables and valves. In particular, the brake pedal cannot be disconnected mechanically from the lower area of the vehicle pan as a practical matter (also due to legal regulations). However, the pedal unit also experiences a linear momentum during a mine explosion, or the like. This can be either through an impact while striking against the torsion bar tunnel, or through transfer of the linear momentum via suspension points, if the suspension is very stable (i.e., rigid). This linear momentum is then transmitted to the foot that is on the pedal, thereby injuring the driver.

DE 101 17 575 A1 describes a device for the protection of the crew during a mine explosion. A foot floor is arranged thereby above the inner floor of the vehicle, which foot floor is supported on one or more inflatable air springs from the inner floor of the vehicle. This serves to disconnect the foot floor from the inner floor of the vehicle, so that the forces resulting from a mine explosion are not transmitted to the foot floor.

From DE 10 2004 054 A1 a foot support is known that is arranged at a specified distance above the inner floor of the vehicle. The foot plate, or a frame part carrying it, is supported on the inner floor of the vehicle via pressure springs and is stabilized towards the inner floor of the vehicle via connecting elements that can transmit only tensile forces, but not compressive forces.

DE 101 30 632 A1 proposes the installation of a vehicle seat in the vehicle so that forces occurring during a mine explosion are received by the underframe.

DE 101 45 279 B4 discloses the incorporation of an intermediate floor in the interior of the vehicle. The height of this intermediate floor is adjustable and it is fastened to the side walls only at suspension mounts.

DE 40 11 963 A1 describes a shock linear momentum-isolating device. This device has springs that have a particularly low stiffness and damping, and are biased.

The above-identified solutions provide for a complete separation of a plate, or the like, from the foot floor (i.e., floorboard) of the vehicle.

Furthermore, it is known to reduce the introduction/transmission of force into the lower legs of the occupants of a vehicle by means of predetermined breaking points. The maximum load exhibited by the driver on the pedal can in practice be up to 1000 N. In addition, these control parts must be designed with a three-fold safeguard against breakage, so that the lower limit up to which the predetermined breaking point must hold is about 3000 N. The force exerted by the driver on the pedal cannot be defined precisely itself because this depends on the height at which the driver places his foot, or the position of the pedal at the instant of mine actuation. Thus, it is not possible to realize a defined predetermined breaking point.

The object of the present invention is to provide a device with which a shock effect on the foot or lower leg of a driver is avoided.

### SUMMARY OF THE INVENTION

The object of the invention is attained by features of a first embodiment pertaining to a pedal (1) for actuating a vehicle, in particular a vehicle protected against mines and/or a military vehicle, wherein the pedal includes: (a) at least two metal sheets (10, 20), or the like, that include a foot metal sheet (10) and a pedal metal sheet (20); and (b) at least two springs (14) between the foot metal sheet (10) and the pedal metal sheet (20), wherein the foot metal sheet (10) has suspension points (13) for the springs (14) and corresponding suspension points (22) are provided on the pedal metal sheet (20), and only the pedal metal sheet (20) is directly connected to the vehicle floor pan of the vehicle via a pan-mounted pivot bearing (23). Advantageous additional embodiments of the present invention are as follows.

In accordance with a second embodiment of the present invention, a pedal according to the first embodiment is modified so that the foot metal sheet (10) is mounted above the pedal metal sheet (20). In accordance with a third embodiment of the present invention, a pedal according to the first and second embodiments is further modified so that the springs (14) are helical tension springs or compression springs. In accordance with a fourth embodiment of the present invention, a pedal in accordance with one of the first through third embodiments is further modified so that the foot metal sheet (10) has laterally mounted contours (11) that interact with bolts (21) mounted on the pedal metal sheet (20). In accordance with a fifth embodiment of the present invention, a pedal according to one of the first through fourth embodiments is further modified so that sides (12) that form an angle in the front and rear are provided on the foot metal sheet (10) to accept the suspension points (13).

The invention is based on the idea of undertaking a disconnecting of the pedals, or of a pedal unit, from the foot of a driver so that a complete transmission of the control forces for gas and braking is guaranteed, but the linear momentum of a mine explosion, or the like, is not transmitted to the foot of the operator of the vehicle.

To this end, the solution, in accordance with the present invention, provides for creating the actual pedal from metal sheets (preferably two), or the like (plastic, etc.), spaced apart from one another, wherein springs are integrated between the metal sheets by means of which the metal sheets are spaced apart from one another and through which changes in length between the metal sheets, due to extreme accelerations, can be accepted without elastic deformation.

In the case of a mine explosion, the two upper suspension points of the springs accomplish a very rapid movement upwards from the starting point, and likewise downwards again, in a short time. The springs (due to the own mass of the spring wire) are not capable hereby of reacting to these changes in spacing of the two suspension points through an elastic deformation (drawing apart) over their entire length. Instead, the upper coils of the springs are plastically deformed.

On the other hand, loads present while driving with distinctly lower accelerations, when they are above 1000 N, for example, are accepted by the elastic deformation of the springs. At loads above a lower limit, the metal sheets come to rest against one another. If the same movement, as in the case of a mine, were to take place much more slowly, the springs would react to the same displacement of their upper suspension points through elastic deformation. This can be the case, for example, with very high dynamic drive loadings (e.g., contact with an obstacle). An overstretching of the springs beyond their elastic range is excluded in this case. Thus, a safeguard against breakage is also completely guaranteed at all dynamic drive loadings.

Preferably, helical tension springs, for example coil springs, are used as the springs when constructing the invention. The use of helical tension springs, instead of compression springs which can likewise be used, prevents a lateral breakaway of the device in a simple manner.

So that the foot metal sheet cannot slip in the normal control condition, it is provided that bolts from the pedal metal sheet engage in a contour in the foot metal sheet and effect a biasing of the helical tension springs.

### BRIEF DESCRIPTION OF THE DRAWINGS

The invention is to be explained in more detail based on an exemplary embodiment illustrated with drawings. They show:

FIG. 1, which is a representation of a foot metal sheet, from the side, in accordance with the present invention.

FIG. 2 is a representation of a pedal metal sheet, in accordance with the present invention, from a side view.

FIG. 3 illustrates a pedal composed of components shown in FIG. 1 and FIG. 2 in the “normal” control condition in a schematic representation.

FIG. 4 shows the pedal from FIG. 3 in the case of a mine explosion.

### DETAILED DESCRIPTION OF THE INVENTION

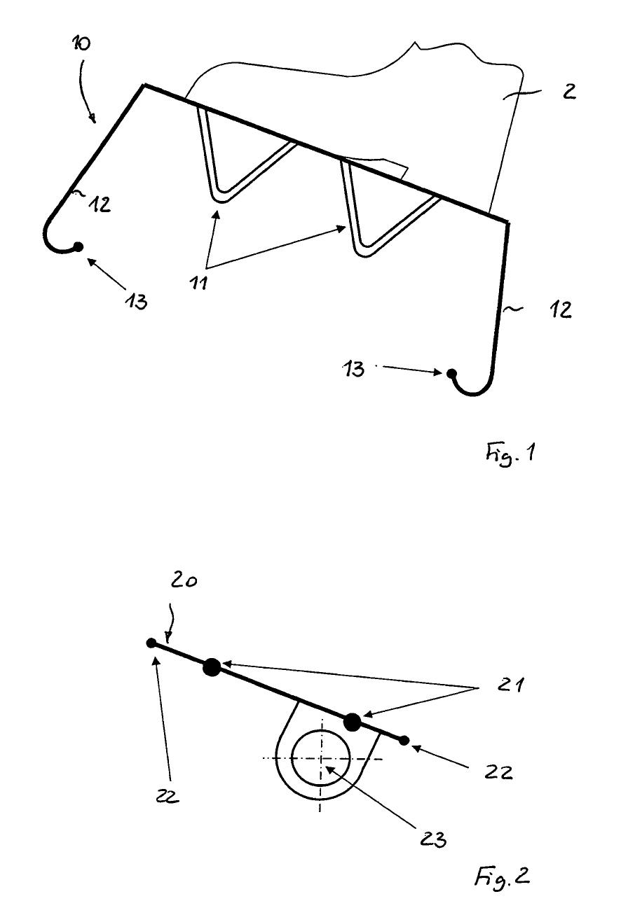

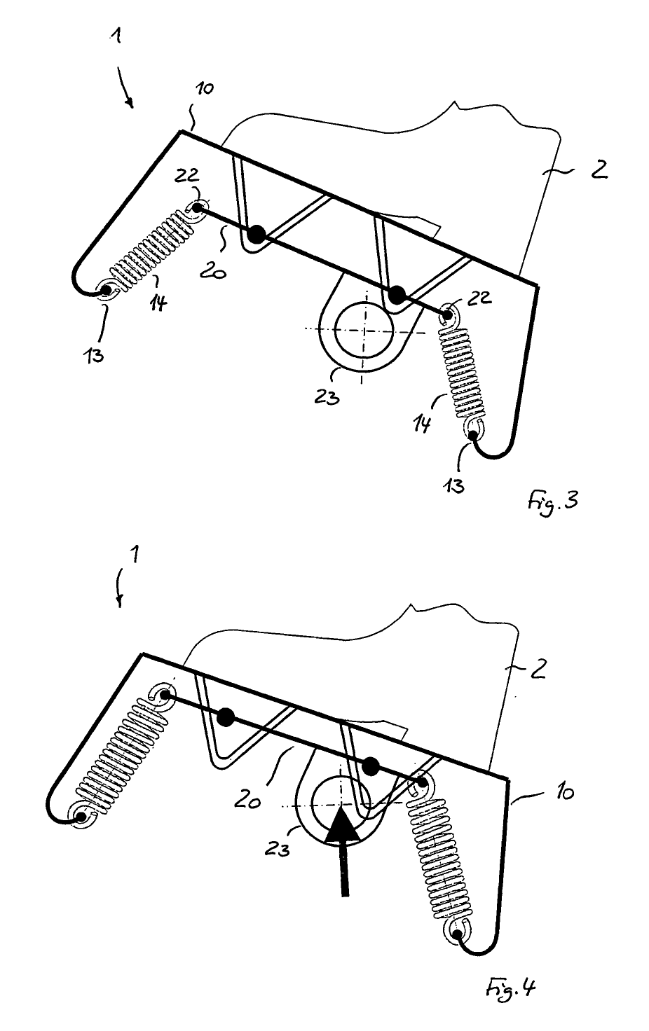

FIG. 1 shows a foot metal sheet 10 that, together with a pedal metal sheet 20 shown in FIG. 2, forms the pedal 1 for a vehicle control ready to be built into the vehicle (See, e.g., FIG. 3, FIG. 4). In accordance with the figures, 2 designates a foot of a driver, not shown in more detail, that rests on the pedal 1, which may be for gas, brake, and/or clutch, for example. The foot metal sheet 10 has laterally attached contours 11 that interact with bolts 21 attached to the pedal metal sheet 20 and prevent a breakaway of the pedal 1. Moreover, the foot metal sheet 10 has sides 12 that form an angle in the front and rear that end in the suspension points 13 for at least two springs 14. The pedal metal sheet 20 has corresponding suspension points 22 for the springs 14. According to the figures, 23 denotes a pan-mounted pivot bearing that takes over the function of the vehicle-mounted support of the pedals.

The connections to the vehicle side are not shown in more detail because these connections are constructed in a manner as with conventional pedals.

FIGS. 3 and 4 show the pedal 1 while functioning, wherein FIG. 3 describes the normal control condition. The foot metal sheet 10 is spaced apart from the pedal metal sheet 20 by means of the at least two springs 14. If there is a shock impact on the pedal 1, the foot metal sheet 10 is displaced with respect to the pedal metal sheet 20 (See FIG. 4). Consequently, a transmission of the linear momentum onto the foot 2 (the feet) does not take place. In the case of a mine explosion, only the first coils of the springs 14 lying on the pedal metal sheet 20 experience a plastic deformation due to the shock of the blast.

1. A pedal for actuating a vehicle mounted in the vehicle, wherein the vehicle is protected against mines, or is a military vehicle, or is a military vehicle protected against mines, wherein the pedal comprises:
(a) at least two metal sheets including, a foot metal sheet and a pedal metal sheet; and
(b) at least two springs disposed between the foot metal sheet and the pedal metal sheet, wherein
the foot metal sheet has first suspension points for the springs and corresponding second suspension points are provided on the pedal metal sheet, and the vehicle includes a vehicle floor pan, and
only the pedal metal sheet is directly connected to the vehicle floor pan of the vehicle via a pan-mounted pivot bearing.

2. A pedal for actuating a vehicle mounted in the vehicle according to claim 1, wherein the foot metal sheet is mounted above the pedal metal sheet.

3. A pedal for actuating a vehicle mounted in the vehicle according to claim 1, wherein the springs are helical tension springs or compression springs.

4. A pedal for actuating a vehicle mounted in the vehicle according to claim 1, wherein the foot metal sheet has laterally mounted contours that interact with bolts mounted on the pedal metal sheet.

5. A pedal for actuating a vehicle mounted in the vehicle according to claim 1, wherein sides that form an angle in a front and rear of the pedal are provided on the foot metal sheet to accept the first suspension points.

6. A pedal for actuating a vehicle mounted in the vehicle according to claim 2, wherein the springs are helical tension springs or compression springs.

7. A pedal for actuating a vehicle mounted in the vehicle according to claim 2, wherein the foot metal sheet has laterally mounted contours that interact with bolts mounted on the pedal metal sheet.

8. A pedal for actuating a vehicle mounted in the vehicle according to claim 3, wherein the foot metal sheet has laterally mounted contours that interact with bolts mounted on the pedal metal sheet.

9. A pedal for actuating a vehicle mounted in the vehicle according to claim 6, wherein the foot metal sheet has laterally mounted contours that interact with bolts mounted on the pedal metal sheet.

10. A pedal for actuating a vehicle mounted in the vehicle according to claim 2, wherein sides that form an angle in a front and rear of the pedal are provided on the foot metal sheet to accept the first suspension points.

11. A pedal for actuating a vehicle mounted in the vehicle according to claim 3, wherein sides that form an angle in a front and rear of the pedal are provided on the foot metal sheet to accept the first suspension points.

12. A pedal for actuating a vehicle mounted in the vehicle according to claim 4, wherein sides that form an angle in a front and rear of the pedal are provided on the foot metal sheet to accept the first suspension points.

13. A pedal for actuating a vehicle mounted in the vehicle according to claim 5, wherein sides that form an angle in a front and rear of the pedal are provided on the foot metal sheet to accept the first suspension points.

14. A pedal for actuating a vehicle mounted in the vehicle according to claim 6, wherein sides that form an angle in a front and rear of the pedal are provided on the foot metal sheet to accept the first suspension points.

15. A pedal for actuating a vehicle mounted in the vehicle according to claim 7, wherein sides that form an angle in a front and rear of the pedal are provided on the foot metal sheet to accept the first suspension points.

16. A pedal for actuating a vehicle mounted in the vehicle according to claim 8, wherein sides that form an angle in a front and rear of the pedal are provided on the foot metal sheet to accept the first suspension points.

17. A pedal for actuating a vehicle mounted in the vehicle according to claim 9, wherein sides that form an angle in a front and rear of the pedal are provided on the foot metal sheet to accept the first suspension points.
